(19) United States
(12) Patent Application Publication
(10) Pub. No.: US 2004/0078280 A1
(43) Pub. Date: Apr. 22, 2004

(54) Business-to-business information exchange system

(76) Inventor: Kevin G. Collins, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/274,716

(22) Filed: Oct. 21, 2002

(51) Int. Cl. G06F 15/173; G06F 17/60; G06F 15/16

(52) U.S. Cl. 705/26; 709/218

(57) ABSTRACT

A method for transferring data from a first computer system to a second computer system. In a representative embodiment, first and second computer systems are connectable via a communication link. On the first computer system, the method steps include requesting data requirements from the second computer system, receiving the data requirements from the second computer system, and transmitting data to the second computer system. The data satisfies the previously received data requirements.

### BACKGROUND

The advent of computer aided design (CAD) of products and the related computer aided manufacturing (CAM) for those products has resulted in significant improvements in productivity for both areas. In the computer aided design arena, an operator creates computer files containing digital data that describe key aspects of the product which are necessary for the manufacture of the product at various stages in the manufacturing process. For example, in the manufacture of through-hole printed circuit boards a drill file is created which specifies the placement and size of the holes to be drilled in the board. Such holes are typically used for the mounting of components onto the board and for electrical connection between the various layers of the board. Since some designs can literally include thousands of drilled holes, modem through-hole printed circuit boards having large numbers of components and through-hole interconnections only became possible with the availability of computer aided design systems that specify hole parameters once at design and with the availability of numerically controlled drilling machines that use this data over and over again during board manufacture.

In other areas of printed circuit board design, computer data files describing exposure geometries on photomasks to be used in the creation of required geometries for various layers during specified manufacturing steps are again created and stored. These files are then transferred to an appropriate manufacturing machine for creation of the photomask. As the photomask has only a limited useful life because of defects that are created in the photomask during the manufacturing process, new photomasks must be created periodically from the same computer aided design data.

Thus, there is a need for a system for the automatic format conversion and transfer of computer aided design data from the design center to computer manufacturing data at the manufacturing center.

### SUMMARY

In a representative embodiment, a method for transferring data from a first computer system to a second computer system is disclosed. First and second computer systems are connectable via a communication link. On the first computer system, the method steps comprise requesting data requirements from the second computer system, receiving the data requirements from the second computer system, and transmitting data to the second computer system. The data satisfies the previously received data requirements.

In another representative embodiment, a program storage medium readable by a first computer system, embodies a software program of instructions executable by the first computer system to perform method steps for transferring data from the first computer to a second computer system. First and second computer systems are connectable via a network. On the first computer system, the software program of instructions comprises requesting data requirements from the second computer system, receiving the data requirements from the second computer system, and transmitting data to the second computer system. The data satisfies the previously received data requirements.

In yet another representative embodiment, a means for transferring data from a first computer system to a second computer system is disclosed. First and second computer systems are connectable via a communication link. The means for transferring data comprises means for requesting data requirements from the second computer system, means for receiving the data requirements from the second computer system, and means for transmitting data to the second computer system. The data satisfies the previously received data requirements.

And in still another representative embodiment, a first computer system for transferring data from the first computer system to a second computer system is disclosed. First and second computer systems are connectable via a communication link. The first computer system comprises functions for requesting data requirements from the second computer system, receiving the data requirements from the second computer system, and transmitting data to the second computer system. The data satisfies the previously received data requirements.

### BRIEF DESCRIPTION OF THE DRAWINGS

The accompanying drawings provide visual representations which will be used to more fully describe various representative embodiments and which can be used by those skilled in the art to better understand these embodiments and their inherent advantages. In these drawings, like reference numerals identify corresponding elements.

FIG. 1 is a drawing of an information exchange system.

FIG. 2 is another drawing of the information exchange system of FIG. 1.

FIG. 3 is still another drawing of the information exchange system of FIG. 1.

FIG. 4 is yet another drawing of the information exchange system of FIG. 1.

FIG. 5A is a drawing of a flow chart of a method for storing manufacturing data requirements.

FIG. 5B is a drawing of a flow chart of a method for exchanging design data.

FIG. 6A is a drawing of a flow chart of a method for storing order data requirements.

FIG. 6B is a drawing of a flow chart of a method for exchanging order data.

### DETAILED DESCRIPTION

As shown in the drawings for purposes of illustration, the present patent document relates to a novel system for exchange of information, particularly as related to the exchange of product design and/or order information between businesses, as for example between a design/order center and a manufacturing center. Previous methods for such information exchange have required intensive manual intervention in the transfer of design data which can be in a variety of formats to the format required by the manufacturing entities that typically require formats which vary from manufacturer to manufacturer. The drill process in the manufacturer of through-hole printed circuit boards is an example. Numeric control data for the hole pattern of the printed circuit board is created on a computer aided design system by the board designer and varies from one computer aided design system to the next, while on the manufacturing side the format required is dependent upon the drill machine that will be used to drill the holes as it can vary from one drill machine manufacturer to the next. Embodiments discussed herein disclose systems that are capable of integrating and interchanging data from existing design and order systems. Examples of such design systems are Cadence, Mentor Graphics, and Zuken. In representative embodiments, data from design systems external to the data exchange system may be automatically extracted from the external design system. Manual linkage can also be provided between the design systems and the data exchange system. In a similar manner, data from order systems at various locations can be linked manually and/or automatically to the data exchange system.

In the following detailed description and in the several figures of the drawings, like elements are identified with like reference numerals.

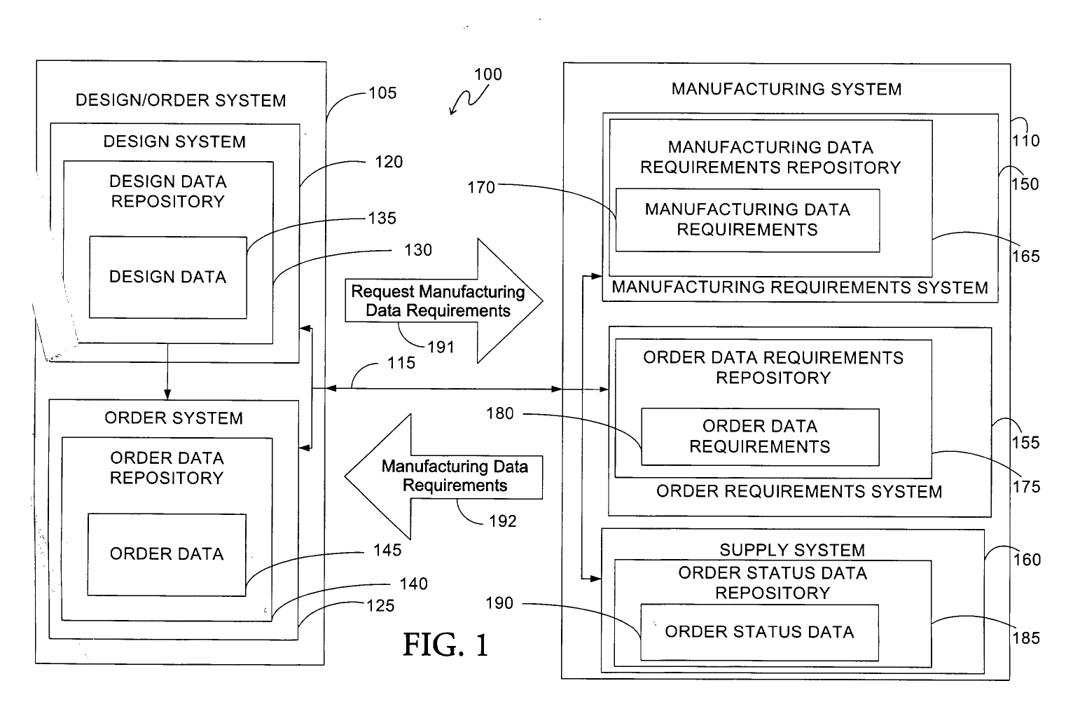

FIG. 1 is a drawing of an information exchange system 100. The information exchange system 100 comprises a design/order system 105, also referred to herein as a customer system 105, and a manufacturing system 110 connected via a communication link 115 which could be, for example, a network 115, the Internet 115, or the like. The communication link 115 could also be a commercial or private telephone system 115 which use modems, for example, for interfacing with the design/order system 105 and the manufacturing system 110.

The design/order system 105 comprises a design system 120 and an order system 125. The design system 120 comprises a design data repository 130 and typically the computer aided design system, not shown in any of the figures, which would normally be used to design a product. The design data repository 130 stores design data 135 and other data typically used in the manufacture of the product.

The order system 125 comprises an order data repository 140 which would normally be used to order a product which is manufactured to the design specifications as reflected in the design data 135. The order data repository 140 stores order data 145 typically used in ordering the product from the manufacturer.

The manufacturing system 110 comprises a manufacturing requirements system 150, an order requirements system 155, and a supply system 160. The manufacturing requirements system 150 comprises a manufacturing data requirements repository 165, as well as other systems, as for example, any computer aided manufacturing system, not shown in any of the drawings, which are typically used in the manufacture of a product. The manufacturing data requirements repository 165 stores manufacturing data requirements 170 which specify the data and format in which the manufacturing system 110 expects to receive data needed to manufacturer the product. Manufacturing data requirements 170 from the manufacturing data requirements repository 165 can be made programmatically accessible via a standard communication protocol and language which could be, for example, the extensible markup language (XML).

The order data requirements system 155 comprises an order data requirements repository 175, as well as any software programs and hardware necessary to store and retrieve order data requirements 180 which are stored in the order data requirements repository 175.

The supply system 160 comprises an order status data repository 185, as well as any software programs and hardware necessary to store and retrieve order status data 190 which are stored in the order status data repository 185.

In FIG. 1, the manufacturer makes available to customer systems 105 the manufacturing data requirements 170 for the manufacturing processes which that manufacturer has for producing the product needed by the designer's entity. This information could be provided to the design/order system 105, for example, in a Standard Generalized Markup Language (SGML) page such as an extensible markup language (XML) page, a HyperText Markup Language (HTML) page, or other structured web document, database, file, or the like. From the design system 120, the designer requests manufacturing data requirements 170 from the manufacturing requirements system 150 in a first message 191 via the communication link 115 between the two systems 120,150. The manufacturing requirements system 150 provides a second message 192 to the design system 120 in response to the query made in the first message 191. The second message 192 comprises a list of design data and data formats which the manufacturer needs in order to be able to produce the designed product.

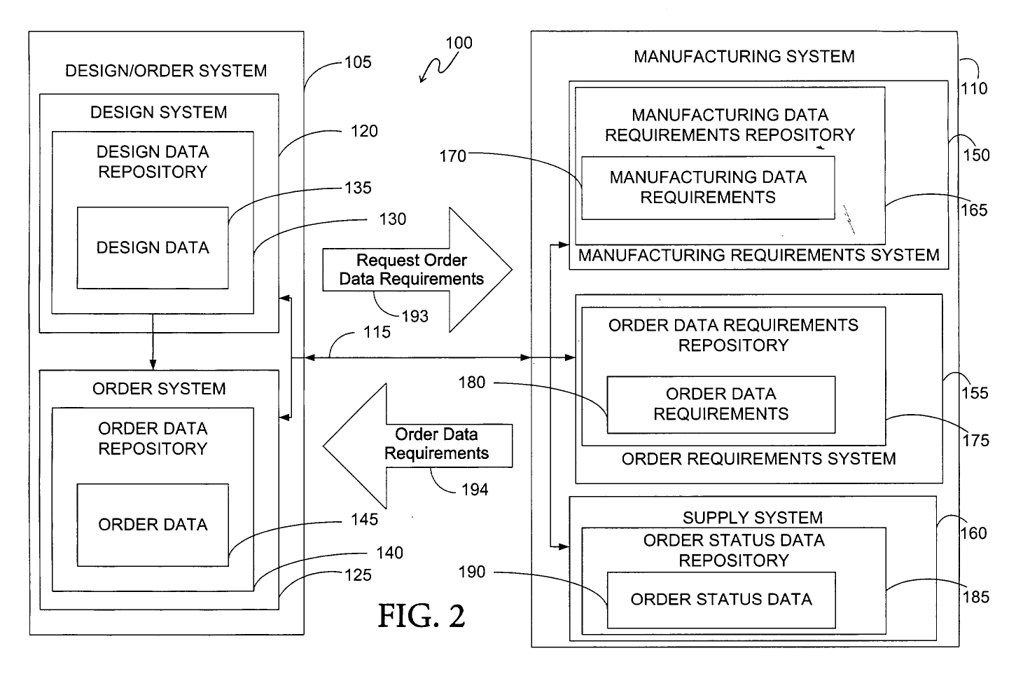

FIG. 2 is another drawing of the information exchange system 100 of FIG. 1. In FIG. 1, the order system 125 requests order data requirements 180 from the order requirements system 155 in a third message 193 via the communication link 115 between the two systems 125,155. The order requirements system 155 provides a fourth message 194 to the order system 125 in response to the query made in the third message 193. The fourth message 194 comprises a list of ordering related data and data formats which the manufacturer needs from the customer in order to initiate a production run of the designed product.

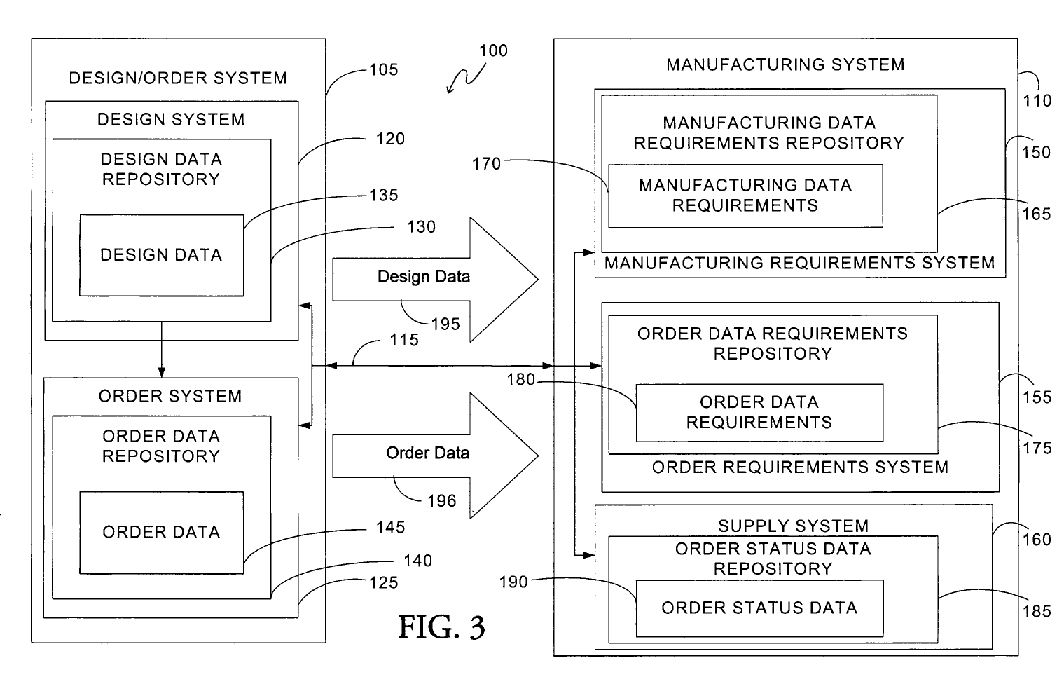

FIG. 3 is still another drawing of the information exchange system 100 of FIG. 1. In FIG. 3 once the design data 135 is available, the design system 120 retrieves the design data 135 from the design data repository 130 and transmits the design data 135 to the manufacturing system 110 in a fifth message 195 via the communication link 115. Again in FIG. 3 once the customer is ready to order product from the manufacturer, the order system 125 retrieves the order data 145 from the order data repository 140 and transmits the order data 145 to the supply system 160 in a sixth message 196 via the communication link 115. It is also possible in representative embodiments for the fifth and sixth messages 195,196 to be transmitted together to the manufacturing system 110 and the supply system 160 respectively.

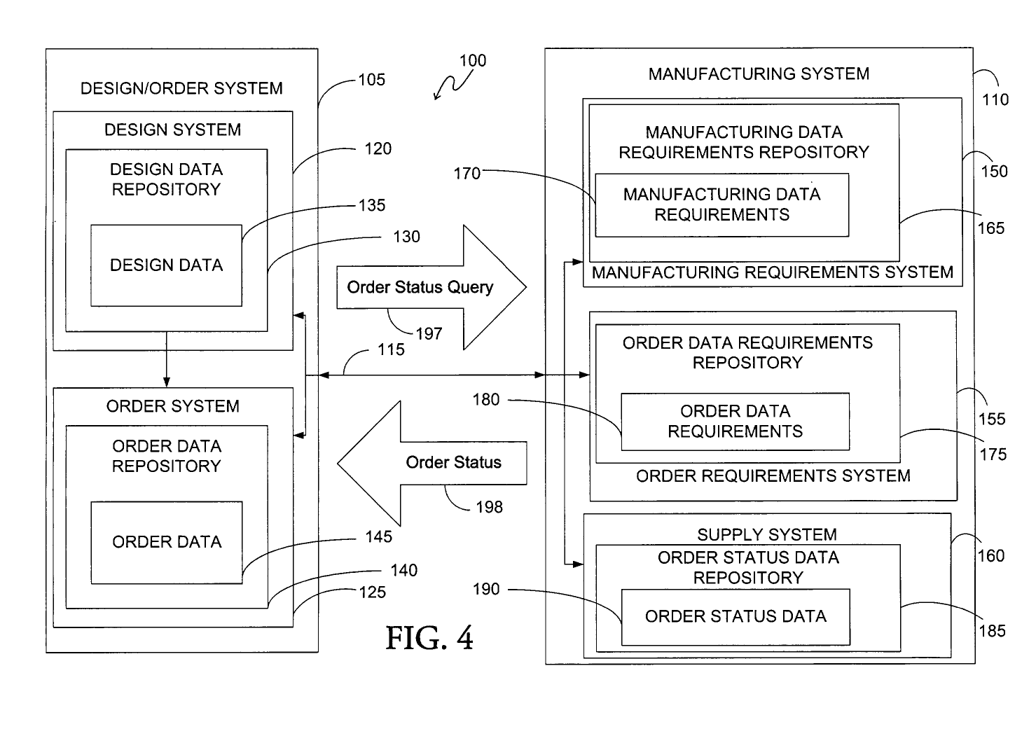

FIG. 4 is yet another drawing of the information exchange system 100 of FIG. 1. Once the customer has ordered product from the manufacturer, the order system 125 can send a query to the supply system 160 requesting the status of the order in a seventh message 197. Such a request, might include questions regarding expected order start date, expected delivery date, current stage in the manufacturing process of the order, and the like. The supply system 160 would then return the order status in an eighth message 198 to the customer system 105. The information returned could, for example, include the information listed above. Thus, the system can facilitate bi-directional communication of order status providing detailed information regarding the order, even including the current manufacturing step of the order. It is also possible for the eighth message 198 to be sent to the customer system 105 in an unsolicited manner.

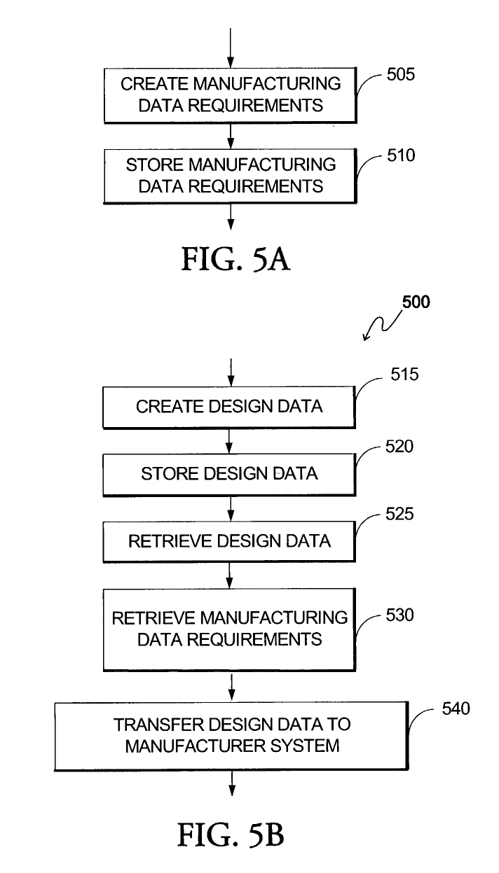

FIG. 5A is a drawing of a flow chart of a method for storing manufacturing data requirements 170. In block 505 of FIG. 5A, manufacturing data requirements 170 are created by the manufacturing requirements system 150. Block 505 then transfers control to block 510.

In block 510, the manufacturing data requirements 170 are stored in the manufacturing data requirements repository 165. Block 510 then terminates the process.

FIG. 5B is a drawing of a flow chart of a method 500 for exchanging design data 135. In block 515 of FIG. 5B, design data 135 for the product is created by the design system 120. Block 515 then transfers control to block 520. As will be readily understood by one skilled in the art the method steps described in blocks 505 and 510 of FIG. 5A are a setup type activity and, as such, are performed less frequently than the processing steps of FIG. 5B that follow.

In block 520, the design data 135 is stored in the design data repository 130. Block 520 then transfers control to block 525.

In block 525, the design data 135 is retrieved from the design data repository 130 and prepared for transfer. Block 525 then transfers control to block 530.

In block 530, the manufacturing data requirements 170 are retrieved from the manufacturing data requirements repository 165. Retrieval of the manufacturing data requirements 170 from the manufacturing data requirements repository 165 involves the design system 120 sending a request to the manufacturing requirements system 150 for a copy of the manufacturing data requirements 170, and the manufacturing requirements system 150 sending a copy of the manufacturing data requirements 170 to the design system 120 in response to that request. The manufacturing data requirements 170 are retrieved so that the customer can compare the manufacturing data requirements 170 with the design data 135 available for transfer to the manufacturing system 110. Block 530 then transfers control to block 540.

In block 540, the design data 135 is transferred to the manufacturing system 110. The manufacturing system 110 then automatically stores the design data 135 and waits for a purchase order from the customer to initiate manufacture of the product. In another embodiment, however, order data and design data may be transferred to the manufacturer's system concurrently in order to expedited the process of manufacturing the product.

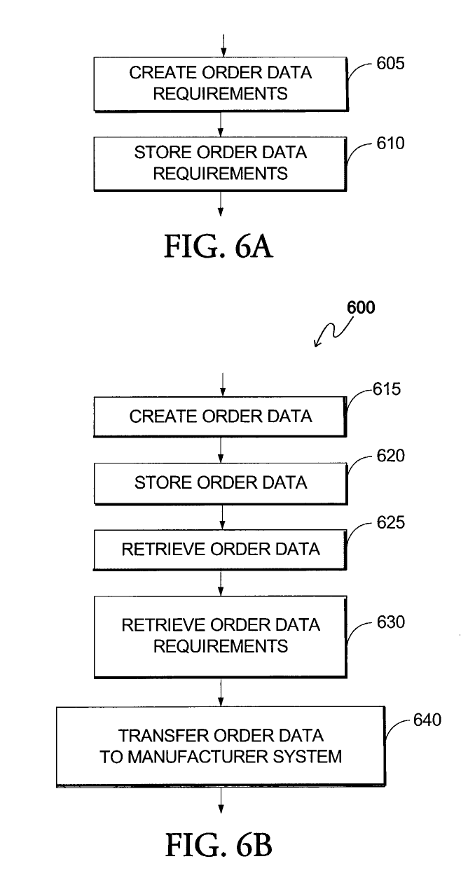

FIG. 6A is a drawing of a flow chart of a method for storing order data requirements 180. In block 605 of FIG. 6A, order data requirements 180 are created by the order requirements system 155. Block 605 then transfers control to block 610.

In block 610, the order data requirements 180 are stored in the order data requirements repository 175. Block 610 then terminates the process.

FIG. 6B is a drawing of a flow chart of a method 600 for exchanging order data 145. In block 615 of FIG. 6B, order data 145 for the product is created by the order system 125. The order data 145 comprises information which the customer typically supplies to the manufacturer when he orders product, as for example a description of the product, a part number, the number ordered, the date by which the customer requires delivery, and the like. Block 615 then transfers control to block 620.

In block 620, the order data 145 is stored in the order data repository 140. Block 620 then transfers control to block 625.

In block 625, the order data 145 is retrieved from the order data repository 140. Block 625 then transfers control to block 630.

In block 630, the order data requirements 180 are retrieved from the order data requirements repository 175. Retrieval of the order data requirements 180 from the order data requirements repository 175 involves the order system 125 sending a request to the order requirements system 155 for a copy of the order data requirements 180, and the order requirements system 155 sending a copy of the order data requirements 180 to the order system 125 in response to that request. The order data requirements 180 are retrieved so that the customer can compare the order data requirements 170 with the order data 145 available for transfer to the manufacturing system 110. Block 630 then transfers control to block 640.

In block 640, the order data 145 is transferred to the manufacturing system 110. The manufacturing system 110 then initiates manufacture of the product.

As is the case, in many data-processing products, the information exchange system 100 may be implemented as a combination of hardware and software components. Moreover, the functionality required for use may be embodied in computer-readable media to be used in programming an information-processing apparatus, such as a computer. The terms “program storage medium” and “computer-readable media” are broadly defined herein to include any kind of computer memory such as, but not limited to, floppy disks, conventional hard disks, DVD's, CD-ROM's, Flash ROM'S, nonvolatile ROM, and RAM. The computer or computers can run any commercially available operating system such as DOS, Windows, or other suitable operating system. The operating system can include support of a database, such as those commercially available from Oracle, Microsoft, Lotus, Corel, or other manufacturers in formats that can support typical data storage and retrieval applications. Embodiments can be advantageously implemented as an application program for a computer system. Such an application program can be written using a variety of programming languages including Visual Basic, C/C++, assembler or any other commercially-available programming tools.

In a representative embodiment, encryption of the data may be performed prior to transfer for purposes of data security. The data is then decrypted upon reception. In another representative embodiment, the decrypted files are in ASCII format so that the files are human-readable for on-line debugging.

Multiple customer design systems producing CAD files with various formats coupled with multiple manufacturer manufacturing systems also having various formats present a complex problem which is solved by the teachings of the embodiments disclosed herein.

A primary advantage of the embodiment as described in the present patent document over prior solutions is that numerous manual steps involved in transferring design/order data from the customer's computer aided design systems at the manufacturer's computer aided manufacturing systems are no longer required. The data format requirements for each manufacturer is now readily available to the design system 120. In addition, the customer is now provided with the ability to more easily and conveniently seek alternate sources for his product as he can readily qualify his data package as meeting the requirements of another manufacturer using the same system.

Embodiments of the disclosed system can provide an interface which is identical among manufacturing facilities, regardless of what the original computer aided design systems are or what manufacturing machines are used at the various manufacturing sites. The binding of actual machine setup to manufacturing data is transparent to the manufacturing operators and is delayed until the last moment. Manufacturing operators do not need to perform machine programming which facilitates the portability of manufacturing data.

Removing the need for numerous manual steps by the manufacturer decreases the design-to-manufacturer time by not only the time to perform these steps but also results in a lower error rate in the final manufacturing data.

Employing an open architecture also can make additions of new features incremental and relatively simple. For example, in the manufacturer of printed circuit boards, bare-board tooling, manufacturing rule checker, thermal analysis, linkage to bare-board testers, EDIF (electronic data interchange format) support, and the like can be added without disturbing the remainder of the system.

What is claimed is:

1. A method for transferring data from a first computer system to a second computer system, wherein first and second computer systems are connectable via a communication link, which comprises the steps of:
on the first computer system:
requesting data requirements from the second computer system;
receiving the data requirements from the second computer system; and
transmitting data to the second computer system, wherein the data satisfies the previously received data requirements.

2. The method as recited in claim 1, wherein the communication link is selected from the group consisting of a network, an internet, and a telephone system.

3. The method as recited in claim 1, wherein the data requirements are received from the second computer system in a structured web document selected from an extensible markup language (XML) page and a HyperText Markup Language (HTML) page.

4. The method as recited in claim 1, wherein the data requirements are manufacturing data requirements and wherein the data is design data for a product.

5. The method as recited in claim 4, wherein the data requirements are received from the second computer system in a structured web document selected from an extensible markup language (XML) page and a HyperText Markup Language (HTML) page.

6. The method as recited in claim 1, wherein the data requirements are order data requirements and wherein the data is order data for a product.

7. The method as recited in claim 6, wherein the data requirements are received from the second computer system in a structured web document selected from an extensible markup language (XML) page and a HyperText Markup Language (HTML) page.

8. The method as recited in claim 6, further comprising: the second computer system automatically providing order status updates to the first computer system.

9. The method as recited in claim 6, further comprising: the first computer system querying the second computer system for an order status update.

10. The method as recited in claim 9, further comprising: the second computer system transmitting the order status update in response to the query from the first computer system.

11. A program storage medium readable by a first computer system, embodying a software program of instructions executable by the first computer system to perform method steps for transferring data from the first computer to a second computer system, wherein first and second computer systems are connectable via a network, comprising:
on the first computer system:
requesting data requirements from the second computer system;
receiving the data requirements from the second computer system; and
transmitting data to the second computer system, wherein the data satisfies the previously received data requirements.

12. The program storage medium as recited in claim 11, wherein the communication link is selected from the group consisting of a network, an internet, and a telephone system.

13. The program storage medium as recited in claim 11, wherein the data requirements are received from the second computer system in a structured web document selected from an extensible markup language (XML) page and a HyperText Markup Language (HTML) page.

14. The program storage medium as recited in claim 11, wherein the data requirements are manufacturing data requirements and wherein the data is design data for a product.

15. The program storage medium as recited in claim 11, wherein the data requirements are received from the second computer system in a structured web document selected from an extensible markup language (XML) page and a HyperText Markup Language (HTML) page.

16. The program storage medium as recited in claim 11, wherein the data requirements are order data requirements and wherein the data is order data for a product.

17. The program storage medium as recited in claim 16, wherein the data requirements are received from the second computer system in a structured web document selected from an extensible markup language (XML) page and a HyperText Markup Language (HTML) page.

18. The program storage medium as recited in claim 16, further comprising: the second computer system automatically providing order status updates to the first computer system.

19. The program storage medium as recited in claim 16, further comprising: the first computer system querying the second computer system for an order status update.

20. The program storage medium as recited in claim 19, further comprising: the second computer system transmitting the order status update in response to the query from the first computer system.

21. A first computer system for transferring data from the first computer system to a second computer system, wherein first and second computer systems are connectable via a communication link, wherein the first computer system comprises functions for requesting data requirements from the second computer system, receiving the data requirements from the second computer system, and transmitting data to the second computer system, wherein the data satisfies the previously received data requirements.

22. The first computer system as recited in claim 21, wherein the communication link is selected from the group consisting of a network, an internet, and a telephone system.

23. The first computer system as recited in claim 21, wherein the data requirements are received from the second computer system in a structured web document selected from an extensible markup language (XML) page and a HyperText Markup Language (HTML) page.

24. The first computer system as recited in claim 21, wherein the data requirements are manufacturing data requirements and wherein the data is design data for a product.

25. The first computer system as recited in claim 24, wherein the data requirements are received from the second computer system in a structured web document selected from an extensible markup language (XML) page and a HyperText Markup Language (HTML) page.

26. The first computer system as recited in claim 21, wherein the data requirements are order data requirements and wherein the data is order data for a product.

27. The first computer system as recited in claim 26, wherein the data requirements are received from the second computer system in a structured web document selected from an extensible markup language (XML) page and a HyperText Markup Language (HTML) page.

28. The first computer system as recited in claim 26, wherein the second computer system is capable of automatically providing order status updates to the first computer system.

29. The first computer system as recited in claim 26, wherein the first computer system is capable of querying the second computer system for an order status update.

30. The first computer system as recited in claim 29, wherein the second computer system is capable of transmitting the order status update in response to the query from the first computer system.

31. A means for transferring data from a first computer system to a second computer system, wherein first and second computer systems are connectable via a communication link, comprising:
means for requesting data requirements from the second computer system;
means for receiving the data requirements from the second computer system; and
means for transmitting data to the second computer system, wherein the data satisfies the previously received data requirements.

32. The means for transferring data from a first computer system to a second computer system as recited in claim 31, wherein the communication link is selected from the group consisting of a network, an internet, and a telephone system.

33. The means for transferring data from a first computer system to a second computer system as recited in claim 31, wherein the data requirements are received from the second computer system in a structured web document selected from an extensible markup language (XML) page and a HyperText Markup Language (HTML) page.

34. The means for transferring data from a first computer system to a second computer system as recited in claim 31, wherein the data requirements are manufacturing data requirements and wherein the data is design data for a product.

35. The means for transferring data from a first computer system to a second computer system as recited in claim 34, wherein the data requirements are received from the second computer system in a structured web document selected from an extensible markup language (XML) page and a HyperText Markup Language (HTML) page.

36. The means for transferring data from a first computer system to a second computer system as recited in claim 31, wherein the data requirements are order data requirements and wherein the data is order data for a product.

37. The means for transferring data from a first computer system to a second computer system as recited in claim 36, wherein the data requirements are received from the second computer system in a structured web document selected from an extensible markup language (XML) page and a HyperText Markup Language (HTML) page.

38. The means for transferring data from a first computer system to a second computer system as recited in claim 36, wherein the second computer system is capable of automatically providing order status updates to the first computer system.

39. The means for transferring data from a first computer system to a second computer system as recited in claim 36, wherein the first computer system is capable of querying the second computer system for an order status update.

40. The means for transferring data from a first computer system to a second computer system as recited in claim 39, wherein the second computer system is capable of transmitting the order status update in response to the query from the first computer system.
